(19) United States
(12) Patent Application Publication
(10) Pub. No.: US 2020/0398305 A1
(43) Pub. Date: Dec. 24, 2020

(54) Aerosol Deposition of Thermographic Phosphor Coatings

(71) Applicant: National Technology & Engineering Solutions of Sandia, LLC, Albuquerque, NM (US)

(72) Inventors: Jacob Thomas Mahaffey, Albuquerque, NM (US); Kathryn N. Gabet Hoffmeister, Albuquerque, NM (US); Andrew Vackel, Albuquerque, NM (US); Wendy Flores-Brito, Albuquerque, NM (US); Deidre Hirschfeld, Albuquerque, NM (US)

(21) Appl. No.: 16/901,492

(22) Filed: Jun. 15, 2020

Related U.S. Application Data
(60) Provisional application No. 62/862,978, filed on Jun. 18, 2019.

(51) Int. Cl. B05D 1/12; C09K 11/77; G01K 11/20; B05B 7/14

(52) U.S. Cl. CPC B05D 1/12; C09K 11/7707; B05B 7/1463; G01K 11/20; C09K 11/7701

(57) ABSTRACT

Aerosol-deposited thermographic phosphors can be used for non-contact, two-dimensional temperature sensing in extreme environments. The fast response time and thermal/environmental stability of doped ceramic powders allow for temperature measurements up to the melting point of the phosphor on hot surfaces, such as rapidly rotating turbine components and combustors.

### CROSS-REFERENCE TO RELATED APPLICATION

This application claims the benefit of U.S. Provisional Application No. 62/862,978, filed Jun. 18, 2019, which is incorporated herein by reference.

### STATEMENT OF GOVERNMENT INTEREST

This invention was made with Government support under Contract No. DE-NA0003525 awarded by the United States Department of Energy/National Nuclear Security Administration. The Government has certain rights in the invention.

### FIELD OF THE INVENTION

The present invention relates to phosphor thermography and, in particular, to the aerosol deposition of thermographic phosphor coatings.

### BACKGROUND OF THE INVENTION

Non-contact, two-dimensional temperature measurements on non-stationary or rotating parts can be extremely difficult to obtain with high accuracy and repeatability. Currently infrared (IR) sensors can be used but can be severely limited in accuracy due to calibration, emissivity changes in the material, and environmental saturation of black-body radiation at IR wavelengths. See M. Vollmer and K.-P. Mollmann, Infrared Thermal Imaging: Fundamentals, Research and Applications, Wiley, 2010. Temperature mapping/modeling of any component can be crucial for materials limitations and geometric considerations. Therefore, the ability to accurately measure temperature with no contact points at near instantaneous speeds (microsecond response times) can greatly increase knowledge to produce better models and understand component geometry and composition.

Phosphorescent materials have been used for non-contact temperature sensing as an alternative to current IR sensing techniques. Phosphors have been used in the past to obtain surface temperature data for engines, gas turbines, and other extreme environments. See S. W. Allison, Rev. Sci. Instrum. 68(7), 2615 (1997); H. Seyfried et al., “Optical Diagnostics for Characterization of a Full-Size Fighter-Jet Afterburner,” in Proc. Turbo Expo 2005: Power for Land, Sea, and Air, Reno, Nev., 813 (2008); A. Omrane et al., Fire Mater. 29(1), 39 (2005); and G. Sarner et al., Meas. Sci. Technol. 19(12), 1 (2008). Temperature readings are produced by exciting the phosphor with a laser of a known wavelength and measuring the resulting phosphorescence (light emitted). Because light is being used to both excite and measure the temperature, near-instantaneous measurements of the temperature can be produced. The use of high-speed cameras allow significant data to be collected at very short time scales. Since the phosphorescent light is received two-dimensionally by the optics, coatings created by phosphors are able to produce heat maps of the corresponding surface based on the resolution of the camera.

Phosphor thermometry is an optical method for surface temperature measurement. Phosphor thermometry relies on the lifetime and intensity properties of the thermographic phosphor's luminescence, which change with temperature. The thermographic phosphor can be an inorganic ceramic powder doped with different elements or activators, which results in a temperature-dependent luminescence. These properties can be exploited to obtain temperature measurements using a spectral ratio method or a lifetime decay method. For example, thermographic phosphors can have a first emission peak at a first wavelength which increases with temperature, and a constant intensity emission at another wavelength. See M. Aldén et al., Prog. Energy Combust. Sci. 37, 422 (2011), which is incorporated herein by reference. Taking data simultaneously at both wavelengths, a ratio (which increases with temperature) between the two emission signals can be used to determine the temperature with the spectral ratio method. The lifetime decay method computes the luminescence duration of the phosphor after excitation, which exponentially shortens as temperature rises.

Phosphor thermography has been successfully used in a number of industrial and scientific applications, including internal combustion engines, gas turbines, fire safety applications, hot gas measurements, and in liquids, including droplets and sprays. In particular, phosphor thermography is often used to measure temperature in combustion environments due to its insensitivity to scattered light, e.g. chemiluminescence from combustion soot. See A. Khalid and K. Kontis, Sensors 8, 5673 (2008); M. Yu et al., Meas. Sci. Technol. 21, 037002 (2010); J. I. Eldridge et al., Meas. Sci. Technol. 27, 125205 (2016); A. Omrane et al., Exp. Therm. Fluid Sci. 28, 669 (2004); A. C. Eckbreth, “Laser Diagnostics for Temperature and Species in Unsteady Combustion,” in Unsteady Combustion, pp. 393-410 (1996); A. Omrane et al., Fire Saf. J. 42, 68 (2007); M. Aldén et al., Prog. Energy Combust. Sci. 37, 422 (2010); and J. BrObach et al., Prog. Energy Combust. Sci. 39, 37 (2013). Depending on the thermographic phosphor used, the temperature range can vary from cryogenic, which ranges from absolute zero to 123° K, to flame temperatures over 1500° K. Due to the characteristic blackbody radiation emission, red-emitting thermographic phosphors cannot be used in high-temperature environments. Dysprosium-doped yttrium-aluminum-garnet (YAG:Dy) is a thermographic phosphor that emits at 455 nm and 497 nm wavelengths (blue emission), and has been demonstrated to work up to temperatures of 1700° K. See M. Aldén et al., Prog. Energy Combust. Sci. 37, 422 (2010); and G. Sarner et al., Meas. Sci. Technol. 19, 125304 (2008). In addition to temperature, thermographic phosphors can also be used to determine velocity and even stress and strain of an object. See S. W. Allison et al., Rev. Sci. Instrum. 68, 2615 (1997); C. Abram et al., Appl. Phys. B 111, 155 (2013); B. Fond et al., Appl. Phys. B 121, 495 (2015); and A. Omrane et al., Appl. Phys. B 92, 99 (2008).

There are two methods to apply the phosphors onto a desired substrate. The first is by synthesizing the phosphor directly on the substrate. The second is bonding the phosphor to the substrate after synthesis of the phosphor. See J. Brübach et al., Prog. Energy Combust. Sci. 39, 37 (2013). Since thermographic phosphors can also be used to measure temperatures of non-stationary components, e.g., rapidly rotating turbine components, the adherence of the phosphor to the surface must be robust. See J. P. Feist et al., Proc. Inst. Mech. Eng. A 217, 193 (2003); and P. Nau et al., J. Eng. Gas Turbines Power 141(4), 041021 (2018). Deposition or bonding of ceramics often requires temperatures above 1000° C., which makes coating lower-melting substrates, such as metals, glasses and polymers, difficult. See P. Sarobol et al., J. Therm. Spray Technol. 25, 82 (2015). Even so, there are currently many methods to bond phosphors onto a substrate of interest after the phosphor has been separately synthesized. The most common method is a chemical bonding process, which is limited by the pyrophoric temperature range of the bonding agent. Therefore, this coating method is not applicable in combustion environments. Though more costly, ceramic phosphors can be deposited using a thermal spray method, such as plasma spray. See J. Brübach et al., Prog. Energy Combust. Sci. 39, 37 (2013). In this technique, both the particles and the substrate are heated, which can be a problem for certain temperature-sensitive applications. Currently, temperature-sensitive test samples are created by simply brushing or hand-spraying (using airbrushes) the phosphor onto the surface, creating a coating that is only dependent of the phosphor's and material's thermal properties, without affecting the component. However, this coating method does not result in strong adherence between the phosphor and the substrate's surface and the coating can be easily scraped off.

Therefore, a need remains for a method for producing a thermographic phosphor ceramic coating with minimal defects, increased mechanical properties such as adherence, and minimal input heat.

### SUMMARY OF THE INVENTION

The present invention is directed to a method to deposit thermographic phosphors, comprising providing a powder of a thermographic phosphor and aerosol depositing the powder on a substrate. The thermographic phosphor can be a ceramic phosphor comprising a ceramic host material doped with a phosphorescing element. The powder can comprise particles of about one micron or less in size. The substrate can be metal, glass, ceramic, or polymer. The invention is further directed to a method for measuring the temperature of a surface, comprising aerosol depositing a thermographic phosphor on a surface, heating the surface to a temperature, and measuring the temperature of the deposited thermographic phosphor using a phosphor thermometry method. The phosphor thermometry method can comprise a spectral ratio method or a lifetime decay method.

As an example of the invention, YAG:Dy coatings from micron-sized powders were aerosol-deposited and thermally tested on copper, stainless-steel, alumina, and borosilicate glass substrates. Aerosol deposition resulted in a strongly bonded coating that retained the thermographic properties of the YAG:Dy. Heat treatments were performed up to 1200° C. to observe phase changes, grain coarsening, or coating delamination. The as-deposited coatings were found to have an average crystallite size of 25 nm, with some grain coarsening above 1000° C. A reduction of 7× was observed in thermal conductivity for the as-deposited coating compared to bulk YAG material, whereas the volumetric heat capacity remained the same.

### BRIEF DESCRIPTION OF THE DRAWINGS

The detailed description will refer to the following drawings, wherein like elements are referred to by like numbers.

FIG. 1 is a schematic illustration of an aerosol deposition process.

FIG. 2 is a scanning electron microscope image of an aerosol-deposited YAG:Dy coating on a copper substrate.

FIGS. 3A and 3B are cross-sectional SEM images of YAG:Dy coating on stainless steel cylinder produced by aerosol deposition.

FIG. 4 is a graph of emission peak signal ratios as a function of temperature for various YAG:Dy phosphor coatings, compared to the results of Aldén et al. See M. Aldén et al., Prog. Energy Combust. Sci. 37, 422 (2010).

### DETAILED DESCRIPTION OF THE INVENTION

A common thermographic phosphor is dysprosium-doped yttrium aluminum garnet (YAG:Dy). This thermographic phosphor has high temperature stability and phosphorescent range. However, application of the YAG:Dy phosphor is currently limited to techniques which result in poor adhesion, low emission signal, or crystallographic phase change. In particular, YAG:Dy coatings are commonly applied in two ways: paints/epoxies and plasma spray techniques. Paints/epoxies quickly burn away before the maximum operating temperature of otherwise stable ceramics (up to 2000° K) and result in much lower transmission efficiency and thermal conductivity. See W. Flores-Brito et al., “Measuring Temperatures in Fire Utilizing Thermographic Phosphors,” Sandia National Laboratories, SAND2018-5269 PE, (2018). Plasma-sprayed coatings rely on melting the particles during the deposition process, causing phase changes and rapid quenching, which results in undesirable stresses and damage to the substrate. See S. D. Parukuttyamma et al., J. Am. Ceram. Soc. 84(8), 1906 (2004).

The present invention is directed to aerosol deposition to produce coatings of thermographic phosphors. Aerosol deposition is an attractive technique due to the zero thermal energy input and lack of binders to produce coatings. Aerosol deposition is a relatively new technique that relies solely on the velocity of particles to create highly dense coatings at room temperature through plastic deformation and successive tamping. See J. Akedo, J. Am. Ceram. Soc. 89(6), 1834 (2006); J. Akedo and M. Lebedev, Materia 41(7), 459 (2002); J. Akedo, J. Therm. Spray Tech. 17, 181 (2008); and D. Hanft et al., J. Ceram. Sci. Technol. 6(3), 147 (2015), which are incorporated herein by reference. Resulting coatings are typically characterized by low porosity which can result in less light scattering and higher thermal conductivity compared to other fabrication methods. Coatings are also nano-crystalline due to the nature of the impact consolidation mechanism which relies on particle fracture to small enough sizes to induce plastic deformation. Aerosol deposition was initially proposed as an alternative method to fabricate ceramic-coated materials without the need for high sintering temperatures. This would broaden the range of applications, allowing ceramics to be bonded with materials that have lower melting points. Some of the applications and components on which aerosol deposition has been successfully tested include: aluminum, piezoelectric materials, titanium dioxide, biocomponents, magnetic materials, fuel cells, sensing materials, and batteries. See D. Hanft et al., J. Ceram. Sci. Technol. 6(3), 147 (2015); J. Akedo et al., “Aerosol Deposition (AD) and Its Applications for Piezoelectric Devices,” in Advanced Piezoelectric Materials, pp. 575-614 (2017); P. Sarobol et al., J. Therm. Spray Technol. 25, 82 (2015); and J. Akedo, J. Am. Ceram. Soc. 89, 1834 (2006).

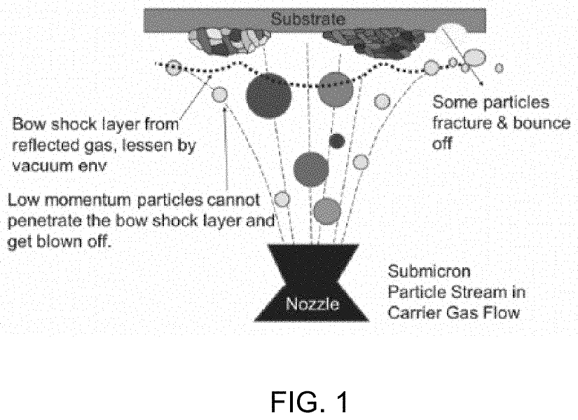

Aerosol deposition uses the kinetic energy (supersonic velocities) of the particles to fracture ceramic particles to small enough sizes to plastically deform and build coatings layer-by-layer. A schematic illustration of an aerosol deposition process is shown in FIG. 1. The aerosol deposition process uses nano-to-micron-sized feedstock particles, which are accelerated to supersonic velocities to create metallic, ceramic, and carbide coatings. The carrier gas usually comprises N₂ or He, and transports dry particles of the desired material to a nozzle, where they are accelerated into a vacuum chamber. Aerosol deposition is conducted in a vacuum to reduce the effect of bow shock, a phenomenon common in similar kinetic coating techniques such as cold spray. The bow shock (or pressure wave) can re-direct the path of the nano-sized particles which is used as feedstock and prevent impact with the substrate. In the absence or reduction of bow shock, the supersonic particles impinge on the surface of the substrate resulting in fragmentation and subsequent plastic deformation (ceramics included) of the particles. This results in a strong mechanical bond between coating and substrate while producing microstructures with grain sizes on the order of 10s of nanometers. See J. Akedo, J. Am. Ceram. Soc. 89, 1834 (2006); J. Akedo and M. Lebedev, Materia 41(7), 459 (2002); P. Sarobol et al., J. Therm. Spray Technol. 25, 82 (2015); and E. Calvié et al., J. Eur. Ceram. Soc. 32, 2067 (2012), which are incorporated herein by reference. Each subsequent collision tamps the surface to produce a highly dense, void-free, adherent coating, capable of large thickness (up to 10s of microns). In addition, the aerosol deposition method can be automated to print a variety of patterns for other applications, e.g., dot patterns for stress and stain diagnostics such as digital image correlation (DIC).

The aerosol-deposited thermographic phosphor can typically be an inorganic ceramic host material doped with an activator, such as a rare-earth element. The doping concentration can be low enough (e.g., few %) so that the dopant atoms are isolated from one another in the host matrix. The host material can be substantially transparent to the excitation radiation such that the activator element absorbs and emits the radiation. A number of temperature-dependent ceramic phosphors can be used. See G. Särner et al., Meas. Sci. Technol. 19, 125304 (2008), which is incorporated herein by reference. As described above, a common thermographic phosphor that can be deposited by aerosol deposition is YAG:Dy. Other doped ceramic phosphors, such as YAG:Tm, YAG:Tb, and red-emitting europium-doped yttrium oxide (Y₂O₃:Eu) and manganese-doped magnesium fluorogermanate (Mg₃F₂GeO₄:Mn), can be used to increase the working range of temperature sensing. See A. H. Khalid and K. Kontis, J. Lumin. 131 (7), 1312 (2011); and W. Flores-Brito et al., “Study of Sensitivity vs. Excitation Time of LED Excited Thermographic Phosphor,” AIAA SciTech Forum (2019), which are incorporated herein the reference.

As an example of the invention, micron-sized particles of YAG:Dy (e.g., 3% dysprosium) were coated onto a variety of substrates with thicknesses ranging from 5 to 30 microns depending on the number of passes that were used during aerosol deposition. No pre-processing of the powder was needed prior to aerosol deposition. Coatings were applied using a custom aerosol deposition chamber. See J. Mahaffey et al., “Aerosol Deposition (AD) for Advanced Manufacturing of Functional Materials,” SAND2018-0179 D. Helium was used as a carrier gas at a flow rate of ˜30 SCFH (standard cubic feet of gas per hours). A custom diverging nozzle was used to deposit the coatings. YAG:Dy powder was injected into the gas stream at using a rotating brush aerosol generator. YAG:Dy was deposited onto copper, stainless-steel, alumina, and borosilicate glass substrates. 1 cm×1 cm square patterns were made by rastering. The vacuum chamber was kept at less than 10 torr during the spray run. The spray deposition parameters are tabulated in Table 1.

TABLE 1
Spray parameters for Aerosol Deposition
of YAG:Dy coatings.

| | Copper, Glass, | |
|---|---|---|
| | Alumina, | |
| Substrate Materials | Stainless Steel | |
| Inlet Pressure | 15 | psi |
| Chamber Pressure | 8.1 | torr |
| Number of passes | 1 | |
| Powder Feed | 20 | mm/hr |
| Traverse Speed | 900 | mm/min |
| Step Size | 0.2 | mm |
| Nozzle Type | DeLaval | |
| Brush Speed | 1200 | RPM |

| | |
|---|---|
| Carrier Gas | Helium |

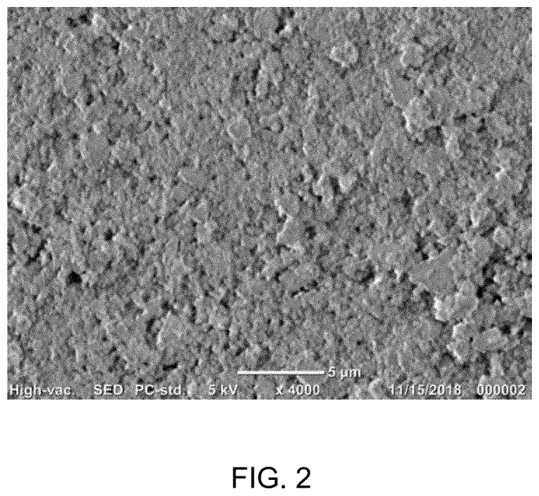

In FIG. 2 is shown a scanning electron microscope (SEM) image of a YAG:Dy deposit on a copper substrate. The surface roughness of the deposits were analyzed with a 3D laser scanning confocal laser microscope to ensure that the method deposits films with consistent thickness and uniformity. Coatings on all substrates had similar roughness measurements (arithmetic mean height, Rₐ˜1.6 μm, and the maximum height of profile, R_{z}˜20.5 μm).

An important feature of aerosol-deposited coatings is that the impact mechanism results in a nano-crystalline microstructure (due to fracture down to a size that can be plastically deformed). See D. Hanft et al., J. Ceram. Sci. Technol. 6(3), 147 (2015). Without the proper velocity of the particles, this fracturing mechanism cannot occur. To ensure that the coatings were in the plastic deformation range, X-ray diffraction (XRD) was used to determine crystallite size. The as-deposited coatings were found to have an average crystallite size of 25 nm, a good indication that the coating was produced using the impact consolidation mechanism proposed in literature. See J. Akedo, J. Therm. Spray Technol. 17(2), 181 (2008). In-situ XRD coupled with heat treatment of the as-deposited coating was performed in order to determine grain growth and phase transformation for typical working temperatures of the coatings. Heat treatment of the resulting coating indicated a general shift upward in crystallite size at temperatures starting at 1000° C., suggesting grain coarsening occurs at elevated temperatures.

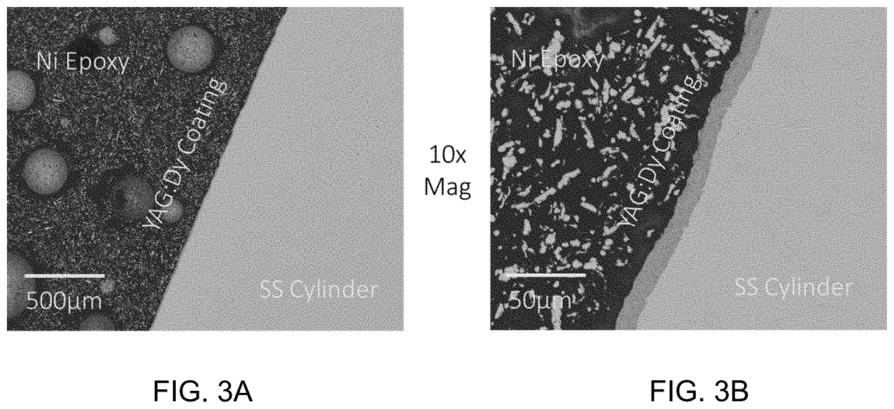

Uniform sub-micron particles can be obtained by ball milling of the powder, albeit at the expense of additional processing. Both ball-milling and heat treatment can be used to produce uniform coatings with nano-crystalline microstructure and high density. It has been suggested that ball-milling not only reduces particle size through fracturing of the particles, but also induces defects into the crystalline lattice which can be aligned to produce grain boundaries during subsequent heat treatment, thus reducing crystallite size in each particle. See H. Park et al., J. Therm. Spray Technol. 5(22), 882 (2013); Y. Kawakami et al., J. Cryst. Growth 275, 1295 (2005); J. Exner et al., Adv. Powder Technol. 26(4), 1143 (2015); and J. Exner et al., J. Eur. Ceram. Soc. 39(2-3), 592 (2019). The addition of a post ball-mill heat treatment results in more consistent powder flowability. For example, a post ball-milled powder was heated for 8 hours at 200° C. before being heat treated at 800° C. for 4 hours. The heat treated powder was used to deposit a YAG:Dy coating onto a ¾ in stainless steel tube. Additional passes on the cylindrical tube were conducted to get a similar thickness in coating comparable to the flat substrates described previously. Scanning electron microscopy (SEM) images of a coating produced on the cylinder with a post ball-mill heat-treated powder are shown in FIGS. 3A and 3B. The coating on a four-pass section of the cylinder was roughly 10-20 microns in thickness. The original surface is nearly preserved. This indicates very little damage is occurring to the underlying substrate. The lack of damage is a direct result of the starting sub-micron particle size. The momentum transfer to the substrate is simply not high enough (as long as erosion is not occurring) to induce significant damage.

Thermal conductivity of the resulting as-deposited coatings was performed using frequency domain thermoreflectance (FDTR). The measured volumetric heat capacity ρcₚ of the aerosol-deposited film was 2.69±0.18 MJ/m³K, within one standard deviation compared to the literature value. See P. H. Klein and W. Croft, J. Appl. Phys., 38(4), 1603 (1967). This was expected as the density of the aerosol-deposited coating was estimated to be >95%. The thermal conductivity was found to be 1.43±0.28 W/mK, which is about 1/7^{th} of bulk material. See P. H. Klein and W. Croft, J. Appl. Phys., 38(4), 1603 (1967); N. Padture and P. Klemens, J. Am. Ceram. Soc. 80(4), 1018 (1997); and J. Lu et al., J. Alloys Compd. 341(1-2), 220 (2002). The reduction of the thermal conductivity from bulk is due to the small crystallite size resulting in a large number of grain boundaries and slight porosity, both of which are expected to lower the thermal conductivity in solids. See G. Soyez et al., Appl. Phys. Lett. 77(8), 1155 (2000); and K. W. Schlichting et al., J. Mater. Sci. 36(12), 3003 (2001). Higher thermal conductivity can be desirable in order to provide faster and more accurate temperature measurements of the substrate. Added heat treatment of the coatings can produce a higher conductivity due to grain growth and reduction of pores. Further, thin coatings can be used to reduce the insulating heat transfer properties may occur due to the low thermal conductivity.

Phosphorescent properties were measured using two color pyrometry. A Q-smart 850 Nd:YAG laser beam, frequency tripled to 355 nm, was used to excite the deposited phosphor. See A. C. Eckbreth, “Laser Diagnostics for Temperature and Species in Unsteady Combustion,” in Unsteady Combustion, pp. 393-410 (1996). A PI-Max4 intensified camera from Princeton Instruments was used for data collection. An image doubler (or stereoscope) from LaVision with 460 nm (10-nm FWHM, ASAHI) and 500 nm (10-nm FWHM, ASAHI) filters was mounted to the intensified camera to obtain and compare emission data with the spectral ratio method. With this image doubler, two images, one at each wavelength, can be obtained simultaneously without the need for two synchronized cameras. These images can then be processed using a MATLAB code to obtain the intensity ratio of 460 nm/500 nm emissions at each temperature. This code first averages the background images, and the background noise average is subtracted from each of the signal images. The code then adds and averages the signal for each temperature. The signals from both wavelengths are in the same image. Therefore, the area for each signal is determined by choosing a small set of pixels (e.g., 672 pixels in total for each set) that align best on top of each other. This results in single-pixel intensity ratio maps. Calibration ratios were also obtained from a small stainless-steel coupon coated with the phosphor-ethanol mix, which was simply painted/brushed onto the surface.

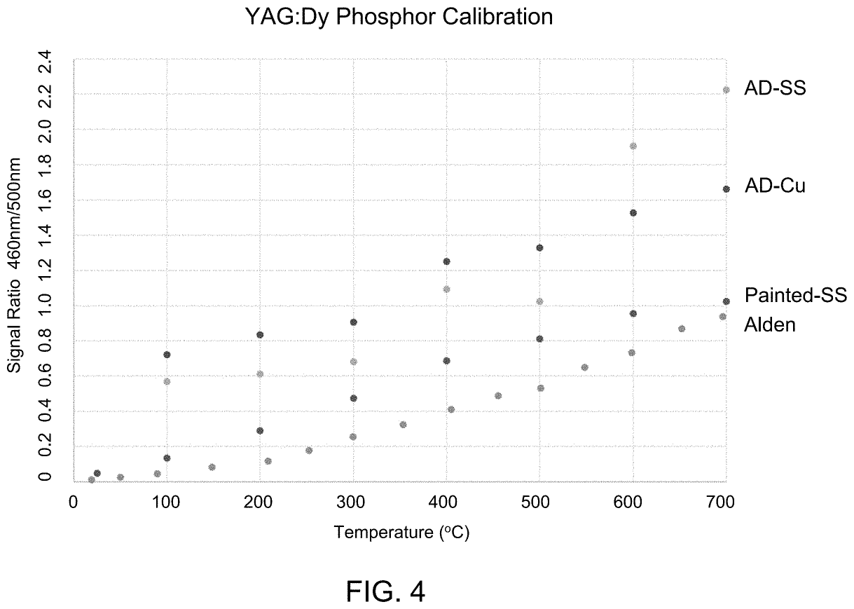

The samples were imaged for a range of sensing temperatures while excited with the 355 nm Nd:YAG beam. FIG. 4 displays these average intensity ratios per temperature for the three samples imaged (aerosol-deposited YAG:Dy on copper and stainless-steel samples, and the painted-on phosphor-ethanol mix sample), compared to results from Aldén et al. See M. Aldén et al., Prog. Energy Combust. Sci. 37, 422 (2010).

The present invention has been described as aerosol deposition of thermographic phosphor coatings. It will be understood that the above description is merely illustrative of the applications of the principles of the present invention, the scope of which is to be determined by the claims viewed in light of the specification. Other variants and modifications of the invention will be apparent to those of skill in the art.

We claim:

1. A method to deposit thermographic phosphors, comprising:
providing a powder of a thermographic phosphor, and
aerosol depositing the powder on a substrate.

2. The method of claim 1, wherein the thermographic phosphor comprises a ceramic phosphor.

3. The method of claim 2, wherein the ceramic phosphor comprises a ceramic host material doped with a rare-earth element.

4. The method of claim 3, wherein the ceramic phosphor comprises a rare-earth-doped yttrium-aluminum-garnet or rare-earth-doped ytrrium oxide.

5. The method of claim 2, wherein the ceramic phosphor comprises manganese-doped magnesium fluorogermanate.

6. The method of claim 1, wherein the powder comprises particles of about one micron or less in size.

7. The method of claim 1, wherein the substrate comprises metal, glass, ceramic or polymer.

8. A method for measuring the temperature of a surface, comprising:
aerosol depositing a thermographic phosphor on a surface,
heating the surface to a temperature, and
measuring the temperature of the deposited thermographic phosphor using a phosphor thermometry method.

9. The method of claim 8, wherein the phosphor thermometry method comprises a spectral ratio method or a lifetime decay method.

10. The method of claim 9, wherein the spectral ratio method comprises;
exciting the emission of a thermographic phosphor with an excitation source,
measuring the intensity of a first emission peak of the thermographic phosphor which increases with temperature at a first wavelength,
measuring the intensity of a second emission peak of the thermographic phosphor which does not change substantially with temperature at a second wavelength, and
ratioing the intensities of the first emission peak and the second emission peak to determine the temperature.
